(19) United States
(12) Patent Application Publication
(10) Pub. No.: US 2025/0205110 A1
(43) Pub. Date: Jun. 26, 2025

(54) EROTIC STIMULATORS

(71) Applicant: HYTTO PTE. LTD.

(72) Inventors: Dan LIU, Guangzhou (CN); Jilin QIU, Guangzhou (CN)

(21) Appl. No.: 18/392,792

(22) Filed: Dec. 21, 2023

(51) Int. Cl. A61H 19/00; A61H 23/02

(52) U.S. Cl. CPC A61H 19/44; A61H 23/0254; A61H 2201/0153; A61H 2201/5097

(57) ABSTRACT

Embodiments of the present invention disclose erotic stimulators. An erotic stimulator includes a housing, a flexible element secured to the housing, a stimulation part, a sensing component configured with a plurality of sensing areas, and a control circuitry. The control circuitry is operatively coupled to at least one of the stimulation part and the sensing component. The control circuitry determines one or more sensing areas triggered among the sensing areas of the sensing component based on at least one operating condition. The one or more sensing areas are triggered while the erotic stimulator contacts the user's body. In one form, the control circuitry operates the stimulation part of the erotic stimulator to perform predefined actions while the erotic stimulator is in contact with the user's body. In another form, the control circuitry generates a control signal for controlling one or more stimulation devices associated with the erotic stimulator.

### TECHNICAL FIELD

The present invention relates generally to devices for sexual pleasure, and more particularly relates to erotic stimulators for providing sexual stimulation to users based on sensory feedback.

### BACKGROUND

Self-sexual intercourse (or masturbation) is a common activity among adults irrespective of gender, race, and so forth. Masturbation is generally referred to as the stimulation of genital organs to obtain sexual pleasure.

Sexual pleasure can be achieved by an individual or a group of individuals (irrespective of gender) by using sex toys. Conventional, sex toys are generally simple and can have a vibration feature for providing sexual pleasure. In conventional sex toys, a degree of sexual stimulation may be manually controlled. However, as these conventional sex toys are self-operated by the individual for experiencing sexual pleasure by using a single setting in the sex toy, the individual may not always feel the same level of stimulation at every instance using the conventional sex toy. Additionally, the arousal of the individual may change periodically based on mood and environment, thus the stimulation produced by the adult toy using the single vibration setting may not satisfy the individual.

In addition, the sex toys may be equipped with electronics (e.g., sensors and network interfaces) for allowing the individual or the group of individuals to experience sexual stimulation without direct physical contact. However, these technologies require built-in sensors in the sex toys to collect the behavioral characteristics of the individual in order to operate the sex toy for providing sexual stimulation. In some cases, the sensors may not appropriately determine the behavioral characteristics of the individual. This leads to a poor understanding of the behavioral and/or psychological characteristics of the two individuals located remotely. As a result, the sex toys may not be operated according to the behavioral characteristics of the individuals (i.e., false triggering of the sex toys due to inaccurate data).

Therefore, there is a need for erotic stimulators for providing a satisfying masturbation experience to the individual, in addition to providing other technical advantages.

### SUMMARY

Various embodiments of the present disclosure disclose erotic stimulators for sexual pleasure.

In an embodiment, an erotic stimulator is disclosed. The erotic stimulator includes a housing Further, the erotic stimulator includes a stimulation part, a sensing component, and a control circuitry. The sensing component is disposed in the housing. The sensing component includes a plurality of sensing areas defined along a length of the sensing component. The plurality of sensing areas in the sensing component is adapted to be triggered while the erotic stimulator is in contact with a user's body. Further, the control circuitry is operatively coupled to at least one of the stimulation part and the sensing component. The control circuitry is configured to determine one or more sensing areas triggered among the plurality of sensing areas of the sensing component based on at least one operating condition. In one scenario, the control circuitry may operate the stimulation part of the erotic stimulator to perform predefined actions corresponding to the one or more sensing areas that are triggered. The stimulation part is disposed at one or more locations in the housing. In another scenario, the control circuitry may generate a control signal corresponding to the one or more sensing areas being triggered, for controlling one or more stimulation devices associated with the erotic stimulator.

In another embodiment, an erotic stimulator for providing sexual stimulation is disclosed. The erotic stimulator includes a housing Further, the erotic stimulator includes a stimulation part, a sensing component, and a control circuitry. The stimulation part is configured with a plurality of operating modes. Further, each operating mode of the plurality of operating modes is predefined for the stimulation part corresponding to a level of each of the plurality of sensing areas of the sensing component. The sensing component is disposed in the housing. The sensing component includes a plurality of sensing areas defined along a length of the sensing component. The plurality of sensing areas in the sensing component is adapted to be triggered while the erotic stimulator is in contact with a user's body. Further, the control circuitry is operatively coupled to at least one of the stimulation part and the sensing component. The control circuitry is configured to determine one or more sensing areas triggered among the plurality of sensing areas of the sensing component based on at least one operating condition. Further, the control circuitry is configured to determine at least a final sensing area of the one or more sensing areas being triggered among the plurality of sensing areas. In one scenario, the control circuitry may operate the stimulation part of the erotic stimulator based on the operating mode determined corresponding to the final sensing area for performing predefined actions. The stimulation part is disposed at one or more locations in the housing. In another scenario, the control circuitry is configured to generate a control signal corresponding to the final sensing area being triggered in the erotic stimulator. The control signal is configured to control one or more stimulation devices associated with the erotic stimulator.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1A illustrates an exploded view of an erotic stimulator, in accordance with an embodiment of the present disclosure;

FIG. 1B illustrates an exploded view of the erotic stimulator of FIG. 1A, depicting a first part and a second part of a housing of the erotic stimulator, in accordance with an embodiment of the present disclosure;

FIG. 2 illustrates a schematic representation of the erotic stimulator of FIG. 1A depicting internal components of the erotic stimulator housed in the housing, in accordance with an embodiment of the present disclosure;

FIG. 3 illustrates a schematic representation of a sensing component of the erotic stimulator, in accordance with an embodiment of the present disclosure;

FIGS. 4A, 4B, and 4C illustrate example scenarios of at least one operating condition for determining one or more sensing areas being triggered in the erotic stimulator, in accordance with an embodiment of the present disclosure;

FIG. 5A illustrates a schematic representation of a sensing component of the erotic stimulator, in accordance with an embodiment of the present disclosure;

FIG. 5B illustrates an example scenario of determining one or more sensing areas being triggered in the erotic stimulator, in accordance with an embodiment of the present disclosure;

FIG. 6 represents an example scenario depicting interaction between users via a user terminal for operating their respective stimulation devices, in accordance with an embodiment of the present disclosure; and

FIG. 7 illustrates a simplified block diagram of a control circuitry of the erotic stimulator, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

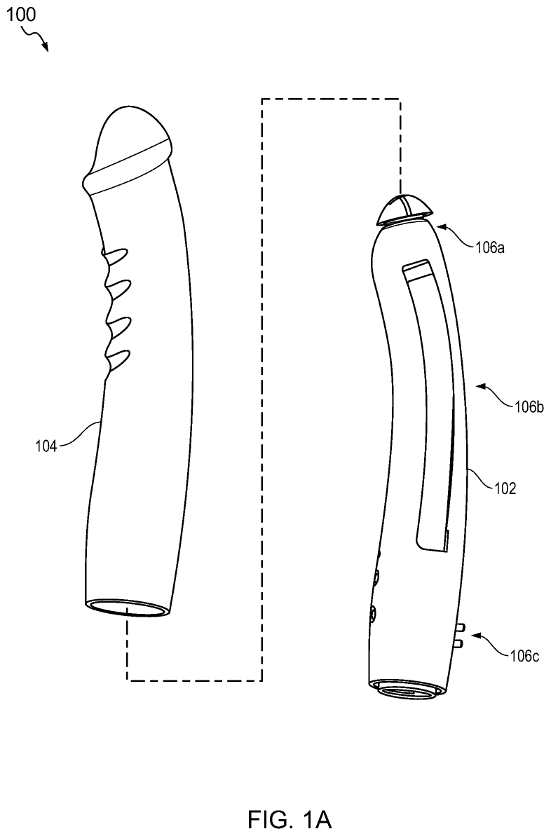

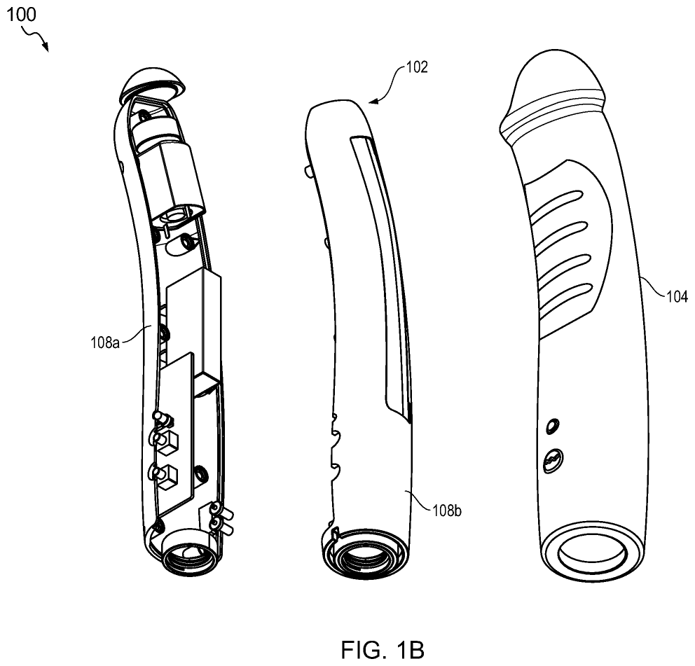

Various embodiments of the present invention are described hereinafter with reference to FIGS. 1A-1B to FIG. 7.

FIG. 1A illustrates an exploded view of an erotic stimulator 100, in accordance with an embodiment of the present disclosure. For the sake of explanation, the erotic stimulator 100 is generally referred to as a vibrator for stimulating genitals (e.g., vagina, clitoris, and surrounding regions), nipples, buttholes, etc. The erotic stimulator 100 represents male genitalia (e.g., penis) and mimics the actions for providing sexual stimulation to users which is further explained in greater detail.

The erotic stimulator 100 includes a housing 102 and a flexible element 104. The housing 102 includes a proximal portion 106a, a central portion 106b, and a distal portion 106c. The housing 102 is configured to encase and/or house one or more components of the erotic stimulator 100. Further, the housing 102 includes a first part (see, 108a of FIG. 1B) and a second part (see, 108b of FIG. 1B). The first part 108a and the second part 108b are detachably coupled to each other to form the housing 102. In an embodiment, the first part 108a and the second part 108b may be configured with a snap-fit arrangement, thus allowing the first part 108a and the second part 108b to be detachably coupled to each other to form the housing 102. Alternatively, the first part 108a and the second part 108b may be configured with other suitable coupling means as per design feasibility and requirement. In another embodiment, the housing 102 may be a unitary structure.

As shown, the housing 102 formed due to the detachable coupling of the first part 108a, and the second part 108b may be in conformity to the shape of the penis. Alternatively, the housing 102 may be configured to be a hollow cylindrical structure, or any other structure as per the design feasibility and requirement. The housing 102 including the first part 108a and the second part 108b may be made a suitable material such as, but not limited to, plastic, metal, rubber, wood, and any combination thereof. Further, the housing 102 may be made of a suitable manufacturing technique, for example, extrusion, molding, and so forth.

Further, the flexible element 104 is removably secured onto the housing 102 for covering a portion of the erotic stimulator 100. The flexible element 104 may be configured in conformity with the structural configuration of the housing 102 to ensure a snug fit of the flexible element 104 onto the housing 102. In one configuration, the flexible element 104 is made of silicone. Alternatively, the flexible element 104 can be made of other materials which possess flexibility or elasticity.

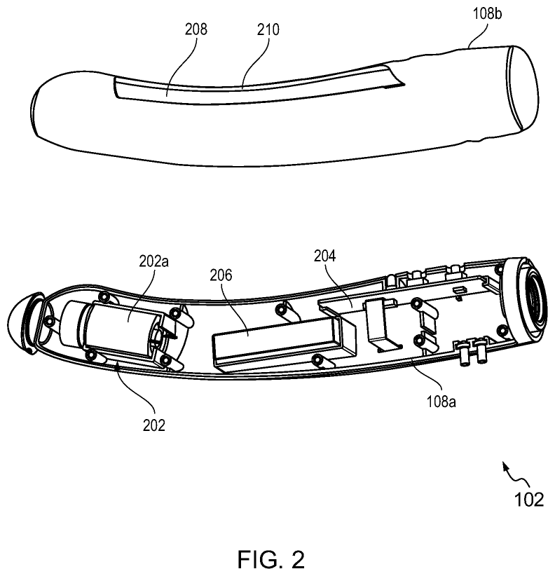

FIG. 2 illustrates a schematic representation of the erotic stimulator 100 depicting internal components of the erotic stimulator 100 housed in the housing 102, in accordance with an embodiment of the present disclosure. As shown, the erotic stimulator 100 includes at least a stimulation part 202, a control circuitry 204, a power source 206, and a sensing component 208. Further, the stimulation part 202, the control circuitry 204, and the power source 206 are disposed in the first part 108a of the housing 102, and the sensing component 208 is disposed in the second part 108b of the housing 102. Alternatively, the stimulation part 202, the control circuitry 204, and the power source 206 may be disposed in the second part 108b of the housing 102.

The stimulation part 202 is disposed at one or more locations in the first part of the housing 102. In particular, the stimulation part 202 is disposed in the proximal portion 106a of the first part 108a of the housing 102. In an embodiment, the stimulation part 202 extends from the central portion 106c to the distal portion 106b of the housing 102. The stimulation part 202 may include an actuator 202a (e.g., motor). In one embodiment, the stimulation part 202 is an integrated part of the erotic stimulator 100. In another embodiment, the entire erotic stimulator (such as the erotic stimulator 100) is configured to the stimulation part. For example, the erotic stimulator 100 may be a dildo that has no other stimulation function but only a sensing function.

Further, the stimulation part 202 is configured with a plurality of operating modes for performing predefined actions to provide sexual stimulation to the user. Further, the control circuitry 204 may include at least one printed circuit board (PCB). The control circuitry 204 is arranged proximal to the distal portion 106b of the housing 102. The control circuitry 204 is operatively coupled to the stimulation part 202, the power source 206, and sensing component 208. The control circuitry 204 is configured to operate the erotic stimulator 100 for providing sexual stimulation to the user.

The power source 206 is configured to provide electrical power to one or more operating components (for example, the actuator 202a, the control circuitry 204, etc.) of the erotic stimulator 100. The power source 206 is arranged proximal to the central portion 106b of the first part 108b of the housing 102. The power source 206 may be configured to provide an alternating current output or a direct current output. In an embodiment, the power source 206 includes a direct current power source, such as a rechargeable battery (for example, a lithium-ion (Li-on) battery), operable to provide the required electrical power for the operation of the stimulation part 202 or the actuator 202a. Further, the power source 206 may include electrical and/or electronic components or circuits for enabling the use of wired or wireless charging. Alternatively, the power source 206 may include electrical and/or electronic components or circuits for enabling the use of alternating current to provide the required electrical power for the operation of the stimulation part 202.

The sensing component 208 is disposed in a groove 210 configured in the second part 108b of the housing 102. The groove 210 extends from the proximal portion 106a to the central portion 106b of the second part 108b of the housing 102. It is to be noted that the groove 210 is configured on at least one side of the second part 108b of the housing 102. Further, a depth of the groove 210 is greater than a thickness of the sensing component 208. The sensing component 208 disposed in the groove 210 is covered by the flexible element 104 when the flexible element 104 is removably secured to the housing 100. The sensing component 210 may be made of conductive materials. For example, the sensing component 210 may be a conductive strip. In an embodiment, the sensing component 208 may be disposed inside the housing 102 or any other suitable location in the housing 102 based on the design feasibility and requirements. In one embodiment, the sensing component 208 can be adhered to an exposed surface of the housing 102. The exposed surface of the housing 102 corresponds to the surface that is in contact with the flexible element 104 when the flexible element 104 is secured to the housing 102.

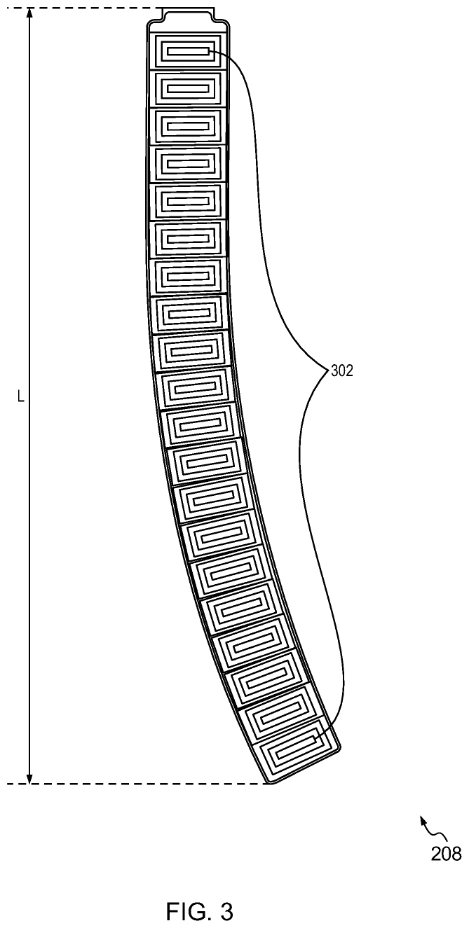

Referring to FIG. 3 in conjunction with FIG. 2, the sensing component 208 includes a plurality of sensing areas (see, 302) defined along a length of the sensing component 208. As shown, each of the sensing areas 302 is defined sequentially (or in a continuous manner) along a length (L) of the sensing component 208. In other words, the sensing areas 302 are arranged in an axial direction of the housing 102.

Further, the sensing areas 302 of the sensing component 208 are adapted to be triggered while the erotic stimulator 100 is in contact with a user's body (e.g., genitalia). In an example scenario, the erotic stimulator 100 may be inserted into female genitalia from the side of the proximal portion 106. The user may self-operate the erotic stimulator 100 being inserted into the male/female user's body (e.g., genitalia, asshole, mouth, etc.). As a result, one or more sensing areas among the sensing areas 302 may be triggered based on the level of insertion of the erotic stimulator 100 in the genitalia. It is to be noted that, a gap (not shown in figures) is defined between the sensing areas 302 and the flexible element 104 due to the depth dimension of the groove 210. In one embodiment, the flexible element 104 undergoes clastic deformation when the erotic stimulator 100 is in contact with the user's body, thereby triggering the one or more sensing areas among the sensing areas 302 during use. In particular, the electrical parameters of the sensing component 208 is changed when the erotic stimulator 100 is in contact with the user's body. This facilitates the sensing areas 302 to be triggered during use.

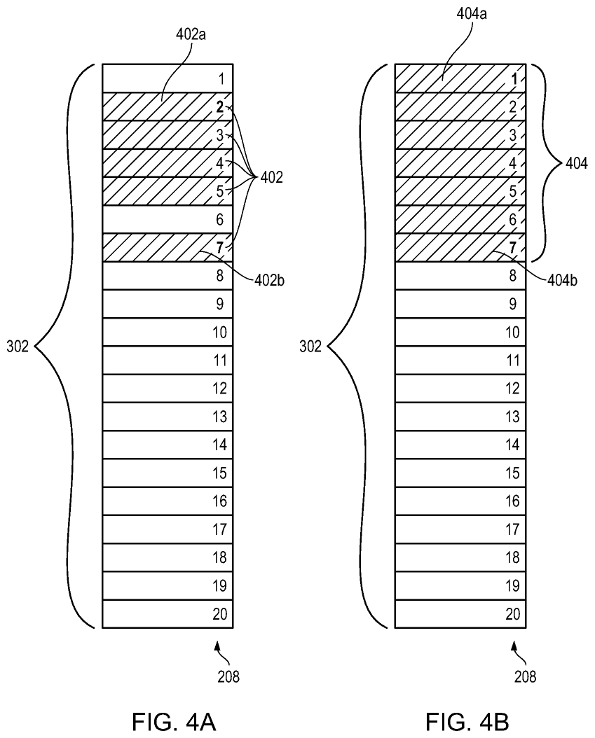

The control circuitry 204 determines the one or more sensing areas triggered among the sensing areas 302 while the erotic stimulator 100 is in contact with the user's body. The control circuitry 204 is configured to operate the stimulation part 202 to perform the predefined actions based on at least one operating condition. In particular, the operating conditions correspond to rules or criteria for at least determining the triggered sensing areas in the sensing component 208, selecting a final sensing area among the triggered sensing area, selecting the operating mode, etc. The operating conditions implemented by the control circuitry 204 for operating the stimulation part 202 are explained with references to FIGS. 4A to 4C.

In one scenario, the control circuitry 204 may operate the stimulation part 202 of the erotic stimulator 100 to perform predefined actions while the erotic stimulator 100 is in contact with the user's body. The predefined actions correspond to a vibrotactile output. In particular, the stimulation part 202 is configured with a plurality of operating modes. Further, each operating mode of the plurality of operating modes is defined for the erotic stimulator 100 corresponding to the level of each of the plurality of sensing areas 302 defined in the sensing component 208. In other words, the intensity of the vibrotactile output (i.e., the predefined actions) is defined corresponding to the level of each of the sensing areas 302. The intensity of the vibrotactile output adjusted based on the level of each of the sensing areas 302 is referred to as the operating mode. It will be apparent that the intensity of the vibrotactile output increases with the level of the sensing area being triggered in the sensing component 208.

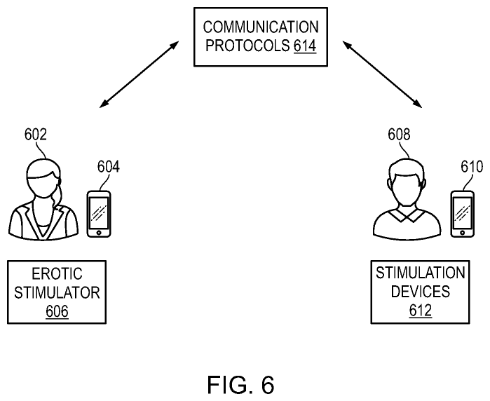

In another scenario, the control circuitry 204 may generate a control signal for controlling one or more stimulation devices associated with the erotic stimulator 100. The stimulation devices may be communicably coupled to the erotic stimulator 100. The control circuitry 204 may transmit the control signal to the stimulation devices via one or more communication protocols which is explained with reference to FIG. 6.

Referring to FIG. 4A, the control circuitry 204 operates the stimulation part 202 based on a first operating condition of the at least one operating condition. As shown, one or more sensing areas (see, 402) are triggered among the sensing areas 302 of the sensing component 208. The triggered sensing areas 402 are provided with hatching or shaded for illustration purposes. For example, twenty sensing areas (i.e., the sensing areas 302) are shown that are arranged sequentially in the sensing component 208. Further, each of the sensing areas 302 is provided with a reference indicator ranging from 1, 2, 3, . . . , to 20. The reference indicator represents a level of each of the sensing areas 302.

As explained above, the one or more sensing areas 402 are triggered while the erotic stimulator 100 is in contact with the user's body (e.g., when the erotic stimulator 100 is inserted in female genitalia from the side of the proximal portion 106a). For instance, five sensing areas (i.e., the sensing areas 402) are triggered among the sensing areas 302. The five sensing areas are exemplarily depicted to be 2^{nd}, 3^{rd}, 4^{th}, 5^{th}, and 7^{th} sensing areas among the twenty sensing areas. In the first operating mode, the control circuitry 204 determines at least an initial sensing area (see, 402a) and a final sensing area (see, 402b) of the sensing areas 402 being triggered among the sensing areas 302 of the sensing component 208. The reference indicators of the initial sensing area 402a and the final sensing area 402b are depicted using bold font for illustration purposes. In the above example scenario, the initial sensing area 402a and the final sensing area 402b are determined to be the 2^{nd} and 7^{th} sensing areas among the five sensing areas 402 that are triggered in the sensing component 208.

Thereafter, the control circuitry 204 determines an operating mode among the plurality of operating modes corresponding to the final sensing area (e.g., 7^{th} sensing area) being triggered in the sensing component 208, for operating the stimulation part 202 to perform the predefined actions. In other words, the control circuitry 204 operates the stimulation part 208 to provide the vibrotactile output corresponding to the final sensing area (e.g., 7^{th} sensing area) of the triggered sensing areas 402. In this scenario, the stimulation part 202 (or the actuator 202a) may be set to 7 levels corresponding to the final sensing area 402b (e.g., 7^{th} sensing area). Thus, in the first operating condition, although the sensing areas 402 are triggered in a discrete fashion, the control circuitry 204 operates the stimulation part 208 based at least on the final sensing area 402b of the triggered sensing areas 402.

Referring to FIG. 4B, the control circuitry 204 operates the stimulation part 202 based on a second operating condition of the at least one operating condition. As shown, one or more sensing areas (see, 404) are triggered among the sensing areas 302 of the sensing component 208. In the second operating condition, the control circuitry 204 may detect whether each of the sensing areas 404 between an initial sensing area (see, 404a) and a final sensing area (see, 404b) of the sensing areas 404 is triggered in the sensing component 208. As shown, each of the sensing areas 404 (e.g., 1^{st} sensing area to 7^{th} sensing area) is triggered among the plurality of sensing areas 302. In this scenario, the control circuitry 204 operates stimulation part 208 to perform the predefined actions corresponding to the final sensing area 404b. In the illustrated embodiment, the final sensing area 404b is exemplarily depicted to be the 7^{th} sensing area. Thus, the control circuitry 204 operates the stimulation part 202 to provide the vibrotactile output corresponding to the final sensing area 404b (e.g., 7^{th} sensing area) of the triggered sensing areas 404. Thus, in the second operating condition, the control circuitry 204 operates the stimulation part 208 in response to detecting each of the sensing areas 404 is triggered in a continuous fashion.

In both operating conditions discussed above, the control circuitry 204 determines the triggered sensing areas based at least on a time parameter. In particular, the control circuitry 204 detects whether a preset number of sensing areas among the sensing areas 302 are triggered within a predefined time (e.g., 2 to 5 seconds). The preset number of sensing areas are the sensing areas that are potential sensing areas among the sensing areas 302 of the sensing component 208 that can be triggered while the erotic stimulator 100 is in contact with the user's body. In case the preset number of sensing areas with initial and final sensing areas are triggered within the predefined time (e.g., 2 to 5 seconds), the preset number of sensing areas are determined to be triggered sensing areas (e.g., the sensing areas 402 and/or the sensing areas 404).

Referring to FIG. 4C, the control circuitry 204 operates the stimulation part 202 based on a third operating condition of the at least one operating condition. In the third operating condition, the control circuitry 204 categorizes the one or more sensing areas based on a threshold time. In particular, the control circuitry 204 determines a first set of sensing areas (see, 406a) among one or more sensing areas (see, 406) that is continuously triggered in a threshold time while the erotic stimulator 100 is in contact with the user's body. In other words, the first set of sensing areas 406a are the sensing areas of the sensing component 208 that remain always inserted into the user's body (e.g., female genitalia) during use, thus resulting in continuous triggering of the first set of sensing areas 406a. Further, the control circuitry 204 determines a second set of sensing areas (see, 406b) among the sensing areas 406 that is intermittently triggered within the threshold time while the erotic stimulator 100 is in contact with the user's body. In other words, the second set of sensing areas 406b is the sensing areas of the sensing component 208 that intermittently contact the user's body (i.e., being inserted into or withdrawn from female genitalia) during use, thus resulting in intermittent triggering of the second set of triggering areas 406b.

In one scenario, the control circuitry 204 determines an operating mode among a plurality of operating modes based at least on the final sensing area (see, 408) of the second set of sensing areas 406b for operating the stimulation part 202 to perform the predefined actions corresponding to the final sensing area of the second set of sensing areas 406b. In another scenario, the control circuitry 204 generates a control signal corresponding to the final sensing area of the second set of sensing areas 406b for controlling the stimulation devices associated with the erotic stimulator 100.

Referring to FIG. 3 in conjunction with FIG. 2, the control circuitry 204 may determine a ratio of the final sensing area of the one or more sensing areas being triggered among the sensing areas 302 of the sensing component 208. In particular, the plurality of sensing areas 302 may be represented in ratios such as 1/10, 2/10, 3/10, etc. Thus, the control circuitry 204 determines the ratio of one or more sensing areas and the final sensing area of the one or more sensing areas that are triggered among the sensing areas 302. Thereafter, the control circuitry 204 operates the stimulation part 202 to perform the predefined actions based on the determined ratio of the final sensing area.

Further, the sensing component 208 is made of conductive materials as explained above. The sensing component 208 made of the conductive materials may be a capacitive sensing component. The sensing component 208 dynamically adjusts at least one electrical parameter (capacitance) corresponding to the final sensing area of the triggered sensing areas as determined in the operating conditions explained with references to FIGS. 4A to 4C. More specifically, when the erotic stimulator 100 contacts the user's body, the capacitance of the sensing component 208 is adjusted based on the level of the final sensing area of the triggered sensing areas in the sensing component 208. For example, the capacitance (C) of the sensing component 208 is computed using the following equation (Eq. 1).

Capacitance, C=ε*S/(4πkd) (Eq. 1)

Wherein,
ε is a dielectric constant,
S is the facing area of the capacitor plate,
d is the distance between the capacitor plates, and
k is the electrostatic force constant.

Due to the capacitance, the current flowing in the control circuitry 204 is adjusted corresponding to a value of the capacitance. For example, current (I) is computed using the following equation (Eq. 2).

Current, I=C×dU/dt (Eq. 2)

Wherein,
U is voltage, and
t is time.

As explained above, the control circuitry 204 operates the stimulation part 202 based at least on the value of the at least one electrical parameter (capacitance and current) corresponding to the final sensing area of the one or more sensing areas being triggered.

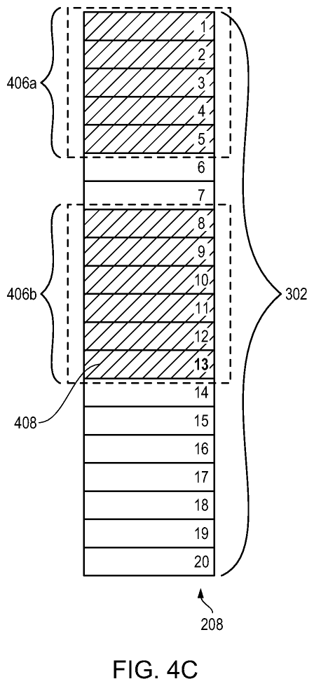

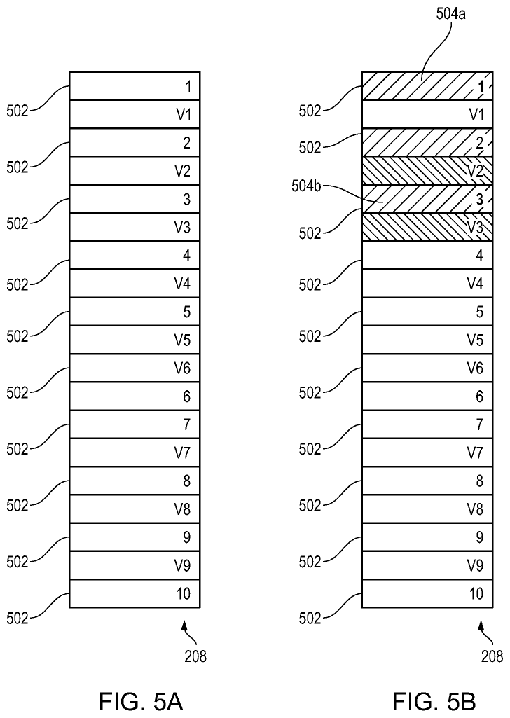

Referring to FIG. 5A, the sensing component 208 may include a plurality of sensing areas 502 defined in a discrete manner. As shown, between each sensing area of the sensing component 108 a void area is defined in the sensing component. For illustration purposes, the sensing areas 502 are represented using a reference indicator ranging from 1, 2, 3 . . . 10. The reference indicator represents a level of each of the sensing areas 502. Further, void areas of the sensing component 208 are exemplarily depicted as ‘V1’, ‘V2’, ‘V3’ . . . ‘V9’. Further, the sensing areas 502 may be arranged in any other configuration as per the design feasibility and requirement.

Referring to FIG. 5B in conjunction with FIG. 5A, one or more sensing areas 504 among the sensing areas 502 are triggered. As shown, ten sensing areas (i.e. the sensing areas are defined in a discrete manner in the sensing component 208. Further, the sensing areas 504 and the void areas (V1-V9) are capable of triggering while the erotic stimulator 100 is in contact with the user's body. For instance, three sensing areas (i.e., the sensing areas 504) are triggered among the ten sensing areas 502. It is to be noted that the void area (i.e., the void area ‘V1’) between the 1^{st} and 2^{nd} sensing areas is left untriggered and the void area (i.e., the void area ‘V2’) between the 2^{nd} and 3^{rd} sensing areas and the void area (i.e., the void area ‘V3’) between the 3^{rd} and 4^{th} sensing areas are triggered. Further, the control circuitry 204 determines an initial sensing area (see, 504a) and a final sensing area (see, 504b) of the triggered areas inclusive of the sensing areas 504 and void areas (V1-V9) of the sensing component 208. It is to be noted that the initial sensing area 504a is among the sensing area 504, and the final sensing area 504b is the void area ‘V3’. In this scenario, the control circuitry 204 operates the stimulation part 202 based on the final sensing area 504b. Particularly, the control circuitry 204 checks for a preceding sensing area that is triggered in the sensing component 208 in case the final sensing area 504b is a void area (e.g., the void area V3). Thereafter, the control circuitry 204 determines the preceding sensing area as the final sensing area 504b that is triggered in the sensing component and operates the stimulation part 202 corresponding to the preceding sensing area of the void area V3. In this scenario, the preceding sensing area is determined to be the 3^{rd} sensing area. Thus, the control circuitry 204 operates the stimulation part 202 to perform the predefined actions corresponding to the 3^{rd} sensing area. Further, the control circuitry 204 operates the erotic stimulator 100 equipped with the sensing component 208 defined with the discrete sensing areas (i.e., the sensing areas 502) in a similar manner as explained with reference to FIGS. 4A to 4C.

FIG. 6 represents an example scenario depicting interaction between users via a user terminal for operating their respective stimulation devices, in accordance with an embodiment of the present disclosure. A first user 602 (exemplarily depicted to be a ‘female user’) is associated with a user terminal 604, and an erotic stimulator 606. The erotic stimulation 606 is an example of the erotic stimulator 100. Further, a second user 608 (exemplarily depicted to be a ‘male user’) is associated with a user terminal 610, and one or more stimulation devices 612. The one or more stimulation devices 612 may include at least the erotic stimulator (such as the erotic stimulator 100), dildos, male masturbating devices, and the like. Further, only two users (the first user 602, and the second user 608) are shown for illustration purposes.

In one example scenario, the erotic stimulator 606 and the stimulation devices 612 may be connected wirelessly to the respective user terminals 604 and 610 of the first user 602 and the second user 608. Some examples of wireless connectivity may be but are not limited to, near-field communication (NFC), wireless fidelity (Wi-Fi), Bluetooth, and the like. In this scenario, the erotic stimulator 606 and the stimulation devices 612 may be monitored and controlled by the user terminal 604 and the user terminal 610, respectively. In another example scenario, the erotic stimulator 606 and the stimulation devices 612 may be equipped with a communication interface or a communicating module. Thus, in both example scenarios, the erotic stimulator 606 may communicate with the stimulation devices 612, or vice versa, based on one or more communication protocols 614 (e.g., internet, cloud server, etc.).

The erotic stimulator 606 may include a sensing component (such as the sensing component 208) defined with a plurality of sensing areas. The sensing areas defined in the erotic stimulator 606 are capable of triggering while the erotic stimulator 606 is in contact with the first user 602. The erotic stimulator 606 may be inserted into the genitals of the first user 602, thereby resulting in the triggering of one or more sensing areas among the plurality of sensing areas of the erotic stimulator 606. In this scenario, a control circuitry (such as the control circuitry 204) of the erotic stimulator 606 may determine a depth of the erotic stimulator 606 being inserted in the genitals of the first user 602 based at least on the one or more sensing areas of the sensing component being triggered.

In one scenario, the control circuitry of the erotic stimulator 606 may operate a stimulation part (such as the stimulation part 202) of the erotic stimulator 606 to perform the predefined actions in response to the depth of insertion of the erotic stimulator 606 in the genitals of the first user 602. In particular, the control circuitry of the erotic stimulator 606 may transmit a trigger signal to the stimulation part of the erotic stimulator 606 for operating the stimulation part to perform the predefined actions. The predefined actions (i.e., the vibrotactile output) provide sexual stimulation to the first user 602 while the erotic stimulator 606 is being inserted in the genitals of the first user 602.

In another scenario, the control circuitry of the erotic stimulator 606 may generate a control signal corresponding to the triggered sensing areas of the erotic stimulator 606. Alternatively, the user terminal 604 may generate the control signal based on the triggered sensing areas of the erotic stimulator 606. Thereafter, the control signal is transmitted to the stimulation devices 612 of the second user 608 via the communication protocols (e.g., internet). The control signal operates the stimulation devices 612 of the second user 608 to provide sexual stimulation to the second user 608 corresponding to the triggered sensing areas of the erotic stimulator 606. Additionally, or alternatively, the erotic stimulator 606 may receive a control signal from the stimulation devices 612. Further, one or more operations related to operating conditions, operating modes, etc., of the erotic stimulator 606 are explained in detail with references to FIGS. 1A-1B to FIGS. 5A-5B, therefore are not reiterated for the sake of brevity.

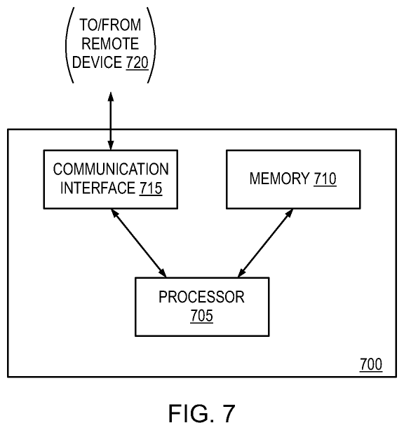

FIG. 7 illustrates a simplified block diagram of a control circuitry 700 of the erotic stimulator 100 or the erotic stimulator 606, in accordance with an embodiment of the present disclosure. The control circuitry 700 is an example of the control circuitry 204. The control circuitry 700 includes at least one processor 705 for executing instructions. Instructions may be stored in, for example, but not limited to, a memory 710.

In an embodiment, the processor 705 may include one or more processing units (e.g., in a multi-core configuration). Examples of the processor 705 include but are not limited to, an application-specific integrated circuit (ASIC) processor, a reduced instruction set computing (RISC) processor, a complex instruction set computing (CISC) processor, a field-programmable gate array (FPGA), and the like. The processor 705 is operatively coupled to a communication interface 715 and is capable of communicating with a remote device 720 such as the user terminal 610, the user terminal 604, or the stimulation devices 612. The one or more operations performed by the control circuitry 700 are already explained with references to FIGS. 1A-1B to 6, and therefore they are not reiterated herein for the sake of brevity.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. An erotic stimulator, comprising:
a housing;
a stimulation part;
a sensing component disposed in the housing, the sensing component comprising a plurality of sensing areas defined along a length of the sensing component, wherein the plurality of sensing areas in the sensing component is adapted to be triggered while the erotic stimulator is in contact with a user's body; and
a control circuitry operatively coupled to at least one of the stimulation part and the sensing component, the control circuitry configured to at least:
determine one or more sensing areas triggered among the plurality of sensing areas of the sensing component based, at least in part, on at least one operating condition, and
in response to determining the one or more sensing areas being triggered in the sensing component, perform at least one of:
operate the stimulation part of the erotic stimulator to perform predefined actions corresponding to the one or more sensing areas being triggered, wherein the stimulation part is disposed at one or more locations in the housing, and
generate a control signal corresponding to the one or more sensing areas being triggered, for controlling one or more stimulation devices associated with the erotic stimulator.

2. The erotic stimulator as claimed in claim 1, wherein the stimulation part is configured with a plurality of operating modes, and wherein each operating mode of the plurality of operating modes is predefined for stimulation part corresponding to a level of each of the plurality of sensing areas of the sensing component.

3. The erotic stimulator as claimed in claim 1, wherein the control circuitry is further configured, at least in part, to:
determine at least an initial sensing area and a final sensing area of the one or more sensing areas being triggered among the plurality of sensing areas of the sensing component, and
determine an operating mode among a plurality of operating modes corresponding to the final sensing area being triggered in the sensing component.

4. The erotic stimulator as claimed in claim 1, wherein the control circuitry is further configured, at least in part, to:
detect whether each of the one or more sensing areas between an initial sensing area and a final sensing area of the one or more sensing areas is triggered in the sensing component; and
in response to determining each of the one or more sensing areas between the initial sensing area and the final sensing area is triggered, operate the stimulation part to perform the predefined actions corresponding to the final sensing area being triggered.

5. The erotic stimulator as claimed in claim 1, wherein the control circuitry is further configured, at least in part, to:
detect whether a preset number of sensing areas among the plurality of sensing areas are triggered within a predefined time; and
determine the preset number of sensing areas as the one or more sensing areas being triggered among the plurality of sensing areas based at least on determining the preset number of sensing areas including an initial sensing area and a final sensing area being triggered within the predefined time.

6. The erotic stimulator as claimed in claim 1, wherein the control circuitry is further configured, at least in part, to:
determine a ratio of the sensing area of the one or more sensing areas being triggered among the plurality of sensing areas of the sensing component, wherein the stimulation part is operated to perform the predefined actions corresponding to the determined ratio corresponding to the sensing area.

7. The erotic stimulator as claimed in claim 1, wherein the control circuitry is further configured, at least in part, to:
determine a first set of sensing areas among the one or more sensing areas that is continuously triggered in a threshold time while the erotic stimulator is in contact with the user's body;
determine a second set of sensing areas among the one or more sensing areas that is intermittently triggered within the threshold time while the erotic stimulator is in contact with the user's body; and
identify a final sensing area of the second set of sensing areas.

8. The erotic stimulator as claimed in claim 7, wherein the control circuitry is further configured, at least in part, to perform at least one of:
determine an operating mode among a plurality of operating modes based at least on the final sensing area of the second set of sensing areas for operating the stimulation part to perform the predefined actions corresponding to the final sensing area of the second set of sensing areas; and
generate a control signal corresponding to the final sensing area of the second set of sensing areas for controlling one or more stimulation devices associated with the erotic stimulator.

9. The erotic stimulator as claimed in claim 1, wherein each of the plurality of sensing areas is defined sequentially along the length of the sensing component.

10. The erotic stimulator as claimed in claim 1, wherein the plurality of sensing areas is defined in a discrete manner along the length of the sensing component, and wherein each of the plurality of sensing areas is configured with unequal dimensions.

11. The erotic stimulator as claimed in claim 1, wherein the sensing component is made of conductive materials, and wherein the sensing component made of the conductive materials dynamically adjusts at least one electrical parameter corresponding to a final sensing area of the one or more sensing areas being triggered while the erotic stimulator is in contact with the user's body.

12. The erotic stimulator as claimed in claim 11, wherein the control circuitry is further configured to operate the stimulation part based at least on a value of the at least one electrical parameter corresponding to the final sensing area of the one or more sensing areas being triggered.

13. The erotic stimulator as claimed in claim 1, wherein the stimulation part is disposed in the proximal portion of the housing, the stimulation part comprising an actuator configured with a plurality of operating modes and operatively coupled to the control circuitry,
wherein the actuator is selectively operated in the plurality of operating modes based on the one or more sensing areas being triggered among the plurality of sensing areas of the sensing component, thus causing the stimulation part to perform the predefined actions, the predefined actions corresponding to a vibrotactile output.

14. The erotic stimulator as claimed in claim 1, further comprising a flexible element adapted to be removably secured onto the housing for covering a portion of the erotic stimulator, wherein the flexible element is made of silicone.

15. The erotic stimulator as claimed in claim 1, further comprising:
a power source operatively coupled to the control circuitry and the stimulation part, the power source configured to provide one of an alternating current output and a direct current output to the control circuitry and the stimulation for operating the erotic stimulator.

16. The erotic stimulator as claimed in claim 1, wherein the erotic stimulator is associated with a first user and the one or more stimulation devices associated with a second user, and wherein, in response to the determining the one or more sensing areas being triggered in the sensing component of the erotic stimulator, the control circuitry is further configured to perform at least one of:
operate the stimulation part to perform the predefined actions, for providing sexual stimulation to the first user corresponding to the one or more sensing areas being triggered, and
transmit a control signal to the second user via one or more communication protocols for controlling the one or more stimulation devices of the second user to provide sexual stimulation to the second user corresponding to the one or more sensing areas being triggered in the erotic stimulator.

17. The erotic stimulator as claimed in claim 16, wherein the erotic stimulator is configured to be inserted into the genitals of the user from the side of a proximal portion of the erotic stimulator, and wherein the control circuitry is further configured to at least determine a depth of the erotic stimulator inserted in the genitals of the first user based at least on the one or more sensing areas of the sensing component being triggered.

18. An erotic stimulator for providing sexual stimulation, comprising:
a housing;
a stimulation part configured with a plurality of operating modes, wherein each operating mode of the plurality of operating modes is predefined for the stimulation part corresponding to a level of each of the plurality of sensing areas of the sensing component;
a sensing component disposed in the housing, the sensing component comprising a plurality of sensing areas defined along a length of the sensing component, wherein the plurality of sensing areas in the sensing component is adapted to be triggered while the erotic stimulator is in contact with a user's body; and
a control circuitry operatively coupled to at least one of the stimulation part and the sensing component, the control circuitry configured, at least in part, to:
determine one or more sensing areas triggered among the plurality of sensing areas of the sensing component based, at least in part, on at least one operating condition,
determine at least a final sensing area of the one or more sensing areas being triggered among the plurality of sensing areas,
determine an operating mode among the plurality of operating modes based on the final sensing area being triggered, and
in response to determining the final sensing area of the one or more sensing areas being triggered, perform at least one of:
operate the stimulation part of the erotic stimulator based on the operating mode determined corresponding to the final sensing area for performing predefined actions, wherein the stimulation part is disposed at one or more locations in the housing, and
generate a control signal corresponding to the final sensing area being triggered in the erotic stimulator, the control signal configured to control one or more stimulation devices associated with the erotic stimulator.

19. The erotic stimulator as claimed in claim 18, wherein the stimulation part is disposed in the proximal portion of the housing, the stimulation part comprising an actuator configured with the plurality of operating modes and operatively coupled to the control circuitry,
wherein the actuator is selectively operated in the plurality of operating modes based on the one or more sensing areas being triggered among the plurality of sensing areas of the sensing component, thus causing the stimulation part to perform the predefined actions, the predefined actions corresponding to a vibrotactile output.

20. The erotic stimulator as claimed in claim 18, wherein the erotic stimulator is associated with a first user and the one or more stimulation devices associated with a second user, and wherein, in response to determining the final sensing areas of the one or more sensing areas being triggered in the erotic stimulator, the control circuitry is further configured, at least in part, to perform at least one of:
operate the stimulation part to perform the predefined actions, for providing sexual stimulation to the first user corresponding to the final sensing area being triggered, and
transmit the control signal to the second user via one or more communication protocols for controlling the one or more stimulation devices of the second user to provide sexual stimulation to the second user corresponding to the final sensing area being triggered in the erotic stimulator.
